(19) United States
(12) Patent Application Publication
(10) Pub. No.: US 2026/0121569 A1
(43) Pub. Date: Apr. 30, 2026

(54) ELECTRIFIED VEHICLE

(71) Applicant: TOYOTA JIDOSHA KABUSHIKI KAISHA, Toyota-shi (JP)

(72) Inventors: Kenta HIROOKA, Toyota-shi (JP); Yuki HAYAKAWA, Okazaki-shi (JP)

(73) Assignee: TOYOTA JIDOSHA KABUSHIKI KAISHA, Toyota-shi (JP)

(21) Appl. No.: 19/250,396

(22) Filed: Jun. 26, 2025

(30) Foreign Application Priority Data
Oct. 28, 2024 (JP) 2024-189354

(51) Int. Cl. H02P 29/028; B60L 3/00; B60L 15/00; B60L 50/60; H02P 25/22

(52) U.S. Cl. CPC H02P 29/028; B60L 3/0038; B60L 15/007; B60L 50/60; H02P 25/22; B60L 2220/56

(57) ABSTRACT

When any of three phases is a first exceeding phase while an electrified vehicle is traveling with a changeover switch being in an on state and with a motor being driven by first and second inverters, it is determined that there is an abnormality in one of the first and second current sensors of three phases, the changeover switch is turned off, and the first and second inverters are controlled such that a current based on a back electromotive force generated by rotation of the motor flows through a circuit configured by the first inverter, the motor, and the second inverter. The first exceeding phase is a phase for which the difference between detection values of the first and second current sensors is greater than a first threshold. An abnormal current sensor is then identified out of the first and second current sensors of the three phases.

### CROSS-REFERENCE TO RELATED APPLICATION

This application claims priority to Japanese Patent Application No. 2024-189354 filed on Oct. 28, 2024. The disclosure of the above-identified application, including the specification, drawings, and claims, is incorporated by reference herein in its entirety.

### BACKGROUND

### 1. Technical Field

The present disclosure relates to electrified vehicles.

### 2. Description of Related Art

An electrified vehicle has been proposed that includes an energy storage device, a traction motor including a three-phase open-end winding, and a first inverter connected to a first end of the three-phase open-end winding. The first inverter is also connected to a power line. This electrified vehicle further includes a second inverter connected to a second end of the three-phase open-end winding, and a changeover switch provided between the first and second inverters on the positive-side line of the power line. The second inverter is also connected to the power line on the opposite side of the first inverter from the energy storage device (see, for example, Japanese Unexamined Patent Application Publication No. 2022-21849 (JP 2022-21849 A)). In this electrified vehicle, a current sensor is attached to each phase of the three-phase open-end winding. During H-drive operation in which the motor is driven by the first and second inverters with the changeover switch in the on state, abnormality diagnosis of the current sensors for the three phases is performed based on the sum of the phase currents of the three phases.

### SUMMARY

In such an electrified vehicle, it is desired to be able to identify an abnormal current sensor when an abnormality occurs in any of the current sensors of the three phases. During H-drive operation, the sum of the phase currents of the three phases may not be zero. Therefore, it may not be possible to identify an abnormal current sensor based on this sum.

A primary object of an electrified vehicle of the present disclosure is to make it possible to identify an abnormal current sensor when an abnormality occurs in any of current sensors of three phases.

In order to achieve the above primary object, the electrified vehicle of the present disclosure adopts the following measures.

An electrified vehicle of the present disclosure includes: an energy storage device; a motor for traction including a three-phase open-end winding; a first inverter connected to a power line and connected to a first end of the three-phase open-end winding; a second inverter connected to the power line on an opposite side of the first inverter from the energy storage device and connected to a second end of the three-phase open-end winding; a changeover switch provided on a positive-side line of the power line between the first and second inverters; and a control device configured to control the first and second inverters and the changeover switch.

The electrified vehicle includes first and second current sensors for each of three phases. The first and second current sensors for each of the three phases are attached to a corresponding phase of the three-phase open-end winding.

The control device is configured to, when any of the three phases is a first exceeding phase while the electrified vehicle is traveling with the changeover switch being in an on state and with the motor being driven by the first and second inverters, determine that there is an abnormality in one of the first and second current sensors of the three phases, turn off the changeover switch, and control the first and second inverters such that a current based on a back electromotive force generated by rotation of the motor flows through a circuit configured by the first inverter, the motor, and the second inverter. The first exceeding phase is a phase for which the difference between detection values of the first and second current sensors is greater than a first threshold.

The control device is configured to then identify an abnormal current sensor out of the first and second current sensors of the three phases, based on the first exceeding phase or a second exceeding phase, and on either the sum of detection values of the first current sensors of the three phases or the sum of detection values of the second current sensors of the three phases, whichever has a larger absolute value. The second exceeding phase is a phase for which the difference between the detection values of the first and second current sensors is greater than a second threshold.

The control device is configured to then control the first and second inverters such that the electrified vehicle travels in a limp home mode without using the abnormal current sensor.

In the electrified vehicle of the present disclosure, the control device is configured to, when any of the three phases is a first exceeding phase while the electrified vehicle is traveling with the changeover switch being in an on state and with the motor being driven by the first and second inverters, determine that there is an abnormality in one of the first and second current sensors of the three phases, turn off the changeover switch, and control the first and second inverters such that a current based on a back electromotive force generated by rotation of the motor flows through a circuit configured by the first inverter, the motor, and the second inverter. The first exceeding phase is a phase for which the difference between detection values of the first and second current sensors is greater than the first threshold. The control device is configured to then identify an abnormal current sensor out of the first and second current sensors of the three phases, based on the first exceeding phase or a second exceeding phase, and on either the sum of the detection values of the first current sensors of the three phases or the sum of the detection values of the second current sensors of the three phases, whichever has a larger absolute value. The second exceeding phase is a phase for which the difference between the detection values of the first and second current sensors is greater than the second threshold. The control device is configured to then control the first and second inverters such that the electrified vehicle travels in the limp home mode without using the abnormal current sensor. With this configuration, it is possible to identify an abnormal current sensor when an abnormality occurs in any one of the current sensors of the three phases.

In the electrified vehicle of the present disclosure, when the control device determines that there is an abnormality in one of the first and second current sensors of the three phases and turns off the changeover switch, the control device may turn on an upper arm of the first and second inverters and turn off a lower arm of the first and second inverters

In the electrified vehicle of the present disclosure, when the control device identifies the abnormal current sensor, the control device may cause the electrified vehicle to travel in the limp home mode by maintaining the changeover switch in an off state, establishing a neutral point at the second end of the three-phase open-end winding, and controlling the first and second inverters to drive the motor through switching of the first inverter. This allows the electrified vehicle to travel in the limp home mode with the changeover switch maintained in the off state. The neutral point may be established at the second end of the three-phase open-end winding by turning on the upper arm of the second inverter and turning off the lower arm of the second inverter.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle according to an embodiment of the present disclosure;

FIG. 2 is a flowchart showing an example of a processing routine that is executed by an electronic control unit (ECU);

FIG. 3 is an illustration showing a state when an identifying process is executed; and

FIG. 4 is a schematic configuration diagram of a battery electric vehicle according to a modification.

### DETAILED DESCRIPTION OF EMBODIMENTS

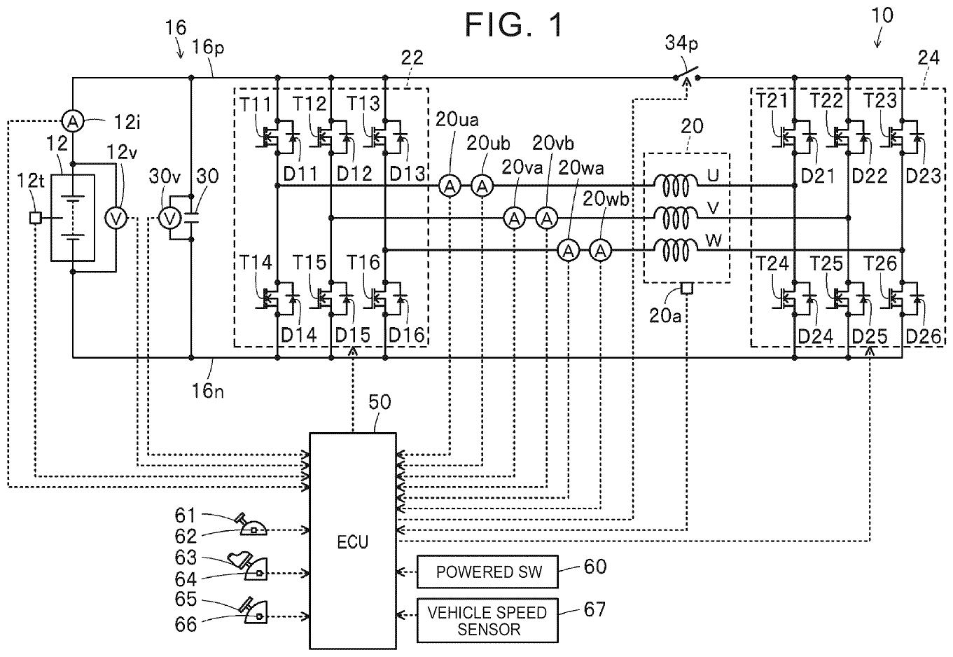

Modes for carrying out the present disclosure (embodiments) will be described with reference to the drawings. FIG. 1 is a schematic configuration diagram of a battery electric vehicle 10 according to an embodiment of the present disclosure. As illustrated, the battery electric vehicle 10 of the embodiment includes a battery 12 as an energy storage device, a motor 20, and first and second inverters 22, 24. The battery electric vehicle 10 of the embodiment includes, as illustrated, a capacitor 30, a changeover switch 34p, and an electronic control unit (hereinafter referred to as “ECU”) 50 as a control device.

The battery 12 is configured as, for example, a lithium-ion secondary battery or a nickel-hydrogen secondary battery, and is connected to the power line 16 (the positive-side line 16p and the negative-side line 16n). The motor 20 is configured as a three-phase AC motor, and includes a rotor in which a permanent magnet is embedded in a rotor core, and a stator in which a three-phase (U-phase, V-phase, and W-phase) coil (three-phase open-end winding) is wound around the stator core. The rotor is connected to a drive shaft connected to the drive wheels via a differential gear.

The first and second inverters 22 each include six transistors T11 to T16, T21 to T26 as six switching elements. Each of the first and second inverters 22 includes six diodes D11 to D16, D21 to D26 connected in parallel from six transistors T11 to T16, T21 to T26. The transistors T11 to T16, T21 to T26 are, for example, MOSFETs or IGBTs. The transistors T11 to T16, T21 to T26 are arranged in pairs so as to be on the source-side and the sink-side with respect to the positive-side line 16p and the negative-side line 16n, 10 respectively. Each of the connecting points of the two transistors that are the pair of the transistors T11 to T16 is connected to each of first ends of the three-phase coils of the motor 20. Each of the connecting points of the two transistors that are the pair of the transistors T21 to T26 is connected to each of the second ends of the three-phase coils of the motor 20. Hereinafter, the transistors T11 to T13 may be referred to as a “first upper arm”, the transistors T14 to T16 may be referred to as a “first lower arm”, the transistors T21 to T23 may be referred to as a “second upper arm”, and the transistors T24 to T26 may be referred to as a “second lower arm”.

The capacitor 30 is connected to the vicinity of the first inverter 22 of the power line 16. In the embodiment, the battery 12, the capacitor 30, the first inverter 22, and the second inverter 24 are connected to the power line 16 in this order from the left side of FIG. 1. The changeover switch 34p is provided between the first and second inverters 22, 24 in the positive-side line 16p. For example, a semiconductor switch or an insulated switch is used as the changeover switch 34p.

The ECU 50 includes a microcomputer having a CPU, ROM, RAM, a flash memory, an input/output port, and a communication port, various driving circuits, and various logic ICs. The ECU 50 receives signals from various sensors. For example, the ECU 50 receives the voltage Vb of the battery 12 from the voltage sensor 12v, the current Ib of the battery 12 from the current sensor 12i, and the temperature Tb of the battery 12 from the temperature sensor 12t. The ECU 50 also receives the rotational position θm of the rotor of the motor 20 from the rotational position sensor 20a, and the phase currents Iua, Iub of the U-phase of the motor 20 from the first and second current sensors 20ua, 20ub attached to the U-phase of the motor 20. The ECU 50 also receives the phase currents Iva, Ivb of the V-phase of the motor 20 from the first and second current sensors 20va, 20vb attached to the V-phase of the motor 20. The ECU 50 also receives the phase currents Iwa, Iwb of the W-phase of the motor 20 from the first and second current sensors 20wa, 20wb attached to the W-phase of the motor 20. As described above, two current sensors are attached to each phase of the motor 20. For each phase, the first current sensors 20ua, 20va, 20wa are the “current sensors of the first channel” and the second current sensors 20ub, 20vb, 20wb are the “current sensors of the second channel”. For example, the current sensor of the first channel is used as a current sensor for current detection, and the current sensor of the second channel is used as a current sensor for abnormality detection (for monitoring the first channel) described later. The voltage VH of the capacitor 30 from the voltage sensor 30v is also input to the ECU 50. The ECU 50 also receives an on/off signal from the power switch 60 and a shift position SP that is an operating position of the shift lever 61 from the shift position sensor 62. The ECU 50 also receives an accelerator operation amount Acc which is a depression amount of the accelerator pedal 63 from the accelerator pedal position sensor 64, and a brake pedal position BP which is a depression amount of the brake pedal 65 from the brake pedal position sensor 66. The ECU 50 also receives the vehicle speed V from the vehicle speed sensor 67.

Various control signals are output from the ECU 50. For example, the ECU 50 outputs a control signal from the transistors T11 to T16 of the first inverter 22, the transistors T21 to T26 of the second inverter 24, and the changeover switch 34p. The ECU 50 calculates the state of charge SOC of the battery 12 based on the integrated value of the current Ib of the battery 12, and calculates the electric angle de and the rotational speed Nm of the motor 20 based on the rotational position θm of the rotor of the motor 20.

In battery electric vehicle 10 of the embodiment, the ECU 50 basically controls the changeover switch 34 and the first and second inverters 22, 24 as follows. The required torque Td* required for driving is set based on the accelerator operation amount Acc and the vehicle speed V, and the torque command Tm* of the motor 20 is set so as to travel according to the set required torque Td*. Then, when the changeover switch 34p is on, switching control is performed on the transistors T11 to T16, T21 to T26 of the first and second inverters 22, 24 such that the motor 20 is driven according to the torque command Tm*. Hereinafter, the control of the changeover switch 34 and the first and second inverters 22, 24 will be referred to as “H drive”.

The first and second inverters 22, 28 are controlled by pulse-width modulation control (PWM control) or square-wave control using the torque command Tm*, the electric angle de, and the phase currents Iu, Iv, Iw of each phase. The phase current Iu of the U-phase is a typical value of the phase currents Iua, Iub of the U-phase of the motor 20 from the first and second current sensors 20ua, 20ub, and for example, a phase current Iua is used. The same applies to the phase currents Iv, Iw of the V-phase and W-phase.

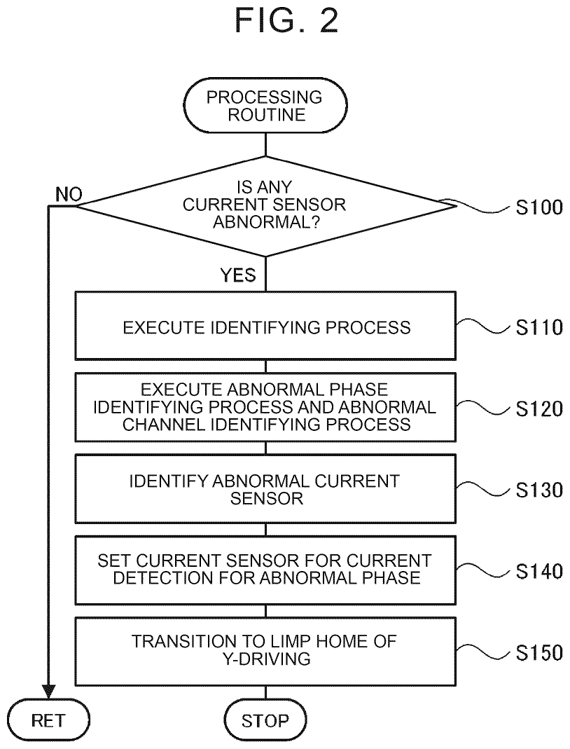

Next, the operation of battery electric vehicle 10 of the embodiment will be described. FIG. 2 is a flowchart illustrating a process routine executed by the ECU 50. This routine is repeatedly executed when the vehicle is traveling in the H drive mode and no anomaly is detected in any of the first and second current sensors 20ua, 20ub, 20va, 20vb, 20wa, 20wb of the U-phase, V-phase, and W-phase.

When this routine is executed, the ECU 50 determines whether all of the U-phase, V-phase, and W-phase first and second current sensors 20ua, 20ub, 20va, 20vb, 20wa, 20wb are normal or abnormal (S100). In this determination process, it is determined that both the first and second current sensor 20ua, 20ub of the U-phase are normal when the difference ΔIu (the absolute value of the demagnetization value from one to the other) of the phase currents Iua, Iub from the first and second current sensors 20ua, 20ub is equal to or smaller than the threshold ΔIuref for the U-phase. In this determination process, when the difference ΔIu is greater than the threshold ΔIuref, it is determined that one of the first and second current sensors 20ua, 20ub of the U-phase is abnormal. In this determination process, it is determined that both of the first and second current sensors 20va, 20vb of the V-phase are normal when the difference ΔIv between the phase currents Iva, Ivb from the first and second current sensors 20va, 20vb of the V-phase is equal to or smaller than the threshold ΔIvref. In this determination process, when the difference ΔIv is greater than the threshold ΔIvref, it is determined that one of the first and second current sensors 20va, 20vb of the V-phase is abnormal. In this determination process, it is determined that both the first and second current sensors 20wa, 20wb of the W-phase are normal when the difference ΔIw between the phase currents Iwa, Iwb from the first and second current sensors 20wa, 20wb is equal to or smaller than the threshold ΔIwref for the W-phase. In this determination process, when the difference ΔIw is greater than the threshold ΔIwref, it is determined that one of the first and second current sensors 20wa, 20wb of the W-phase is abnormal. Each of the thresholds ΔIuref, ΔIvref, ΔIwref is determined based on the specifications (detection errors) of the first and second current sensors 20ua, 20ub for the U-phase etc. Each of the thresholds ΔIuref, ΔIvref, ΔIwref is also determined based on the specifications of the first and second current sensors 20va, 20vb for the V-phase, the specifications of the first and second current sensors 20wa, 20wb for the W-phase, etc. The thresholds ΔIuref, ΔIvref, ΔIwref may all have the same value, or at least one of them may have different values.

When it is determined that all of the U-phase, V-phase, and W-phase first and second current sensors 20ua, 20ub, 20va, 20vb, 20wa, 20wb are normal in S100, the routine ends.

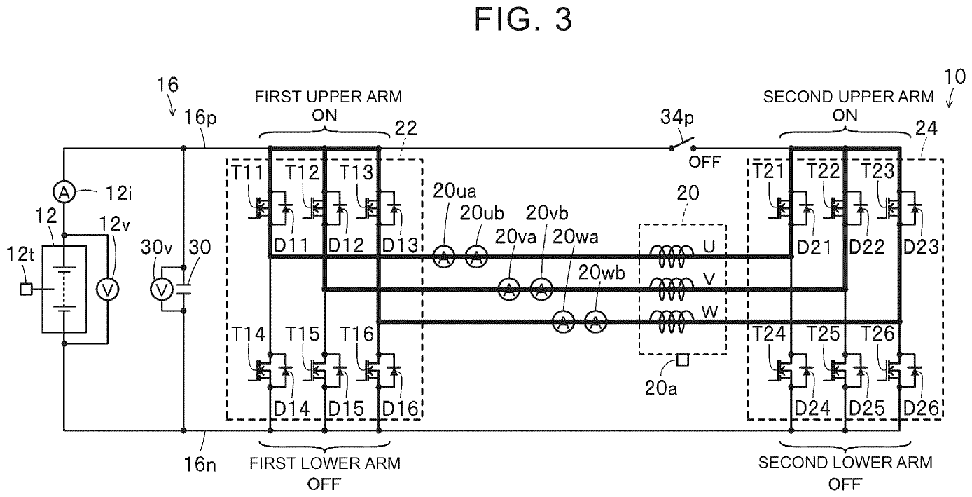

When it is determined that any one of the first and second current sensors 20ua, 20ub, 20va, 20vb, 20wa, 20wb of the U-phase, V-phase, and W-phase is abnormal in S100, an identifying process of identifying the abnormal current sensor is executed (S110). Here, in the identifying process, a process of switching the changeover switch 34p from the on state to the off state is executed. In the identifying process, a process of turning on the first upper arm (transistors T11 to T13) and the second upper arm (transistors T21 to T23) of the first and second inverters 22, 24 is executed. At the same time, in the identifying process, the process of turning off the first lower arm (transistors T14 to T16) and the second lower arm (transistors T24 to T26) is executed. FIG. 3 is a diagram illustrating a state at this time. When the identifying process is executed while the motor 20 is rotating at a certain rotational speed, a circuit is formed by the first upper arm, the motor 20, and the second upper arm as shown by the thick continuous line in FIG. 3. In this circuit, a current based on the back electromotive force caused by the rotation of the motor 20 flows (circulates). In this case, the sum of the actual currents of the U-phase, V-phase, and W-phase of the motor 20 is 0.

Subsequently, an abnormal phase identifying process and an abnormal channel identifying process of identifying the phase (abnormal phase) and the channel (abnormal channel) of the abnormal current sensor are executed (S120). S120 process is directed to the U-phase, V-phase, and W-phase first and second current sensors 20ua, 20ub, 20va, 20vb, 20wa, 20wb.

In the abnormal phase identifying process, the abnormal phase is identified by executing the same process as S100 determination process. In the abnormal channel identifying process, the sum It1 of the phase currents Iua, Iva, Iwa from the current sensors (first current sensors 20ua, 20va, 20wa) of the first channel is calculated. At the same time, in the abnormal channel identifying process, the sum It2 of the phase currents Iub, Ivb, Iwb from the current sensors (second current sensors 20ub, 20vb, 20wb) of the second channel is calculated. When the absolute value of the sum It1 is greater than or equal to the absolute value of the sum It2, the first channel is identified as an abnormal channel. When the absolute value of the sum It1 is less than the absolute value of the sum It2, the second channel is identified as an abnormal channel. As described above, since the sum of the actual currents of the U-phase, the V-phase, and the W-phase of the motor 20 is the value 0, the channel corresponding to the larger absolute value of the sums It1, It2 is identified as the abnormal channel.

When the abnormal phase and the abnormal channel are identified in this way, the abnormal current sensor is identified by the identified abnormal phase and the abnormal channel (S130). For example, when the abnormal phase is the U-phase and the abnormal channel is the first channel, the first current sensor 20ua of the U-phase is identified as the abnormal current sensor. Then, for the abnormal phase, a current sensor other than the abnormal current sensor is set as a current sensor for detecting a current (S140). For example, when the abnormal current sensor is the U-phase first current sensor 20ua, the second current sensor 20ub is used as a current sensor for detecting the U-phase.

Subsequently, the operation mode transitions to a Y-drive limp home mode (S150), and the routine ends. In the Y-drive limp home mode, the changeover switch 34p is maintained in the off state, and a neutral point is established on the second inverter 24 side of the motor 20 (at the second end of the three-phase coil of the motor 20). In addition, in the Y-drive limp home mode, the motor 20 is driven by the switching drive of the first inverters 22 (transistors T11 to T16). A neutral point is established on the second inverter 24 side of the motor 20 by turning on the second upper arm (transistors T21 to T23) of the second inverter 24 and turning off the second lower arm (transistors T24 to T26). In this way, the vehicle can travel in the limp home mode without switching the changeover switch 34p from the off state to the on state.

In battery electric vehicle 10 of the embodiment described above, it may be determined that one of the first and second current sensors 20ua, 20ub, 20va, 20vb, 20wa, 20wb of the U-phase, V-phase, and W-phase is abnormal during traveling in the H drive. In this case, as the identifying process, the changeover switch 34p is turned off, and the first upper arm and the second upper arm are turned on and the first lower arm and the second lower arm are turned off. As a result, a current based on the back electromotive force caused by the rotation of the motor 20 is caused to flow in the circuit of the first upper arm of the first inverter 22, the motor 20, and the second upper arm of the second inverter 24. Then, the abnormal phase and the abnormal channel are identified by the abnormal phase identifying process and the abnormal channel identifying process, and thereby the abnormal current sensor is identified. In this way, an abnormal current sensor can be identified.

In the battery electric vehicle 10 of the embodiment, when the abnormal current sensor is identified, for the abnormal phase, a current sensor other than the abnormal current sensor is set as the current sensor for detecting, and the operation mode transitions to the Y-drive limp home mode. Accordingly, the vehicle can travel in the limp home mode while maintaining the changeover switch 34p in the off state.

In the above embodiment, it is determined whether all the first and second current sensors 20ua, 20ub, 20va, 20vb, 20wa, 20wb of the U-phase, V-phase, and W-phase are normal or abnormal in S100 in the process routine of FIG. 2. In addition, the abnormal phase identifying process and the abnormal channel identifying process are executed in S120. However, the processing routine is not limited thereto. For example, the abnormal phase may also be identified when it is determined in S100 that one of the first and second current sensors 20ua, 20ub, 20va, 20vb, 20wa, 20wb of the U-phase, V-phase, and W-phase is abnormal. For example, when the difference ΔIu is greater than the threshold ΔIuref, the U-phase may be identified as an abnormal phase.

In the above embodiment, when the abnormal current sensor is identified, the operation mode transitions to the Y-drive limp home mode. However, the present disclosure is not limited thereto. For example, the vehicle may be caused to travel in the limp home mode by H-drive operation by switching the changeover switch 34p from the off state to the on state after the vehicle comes to a stop.

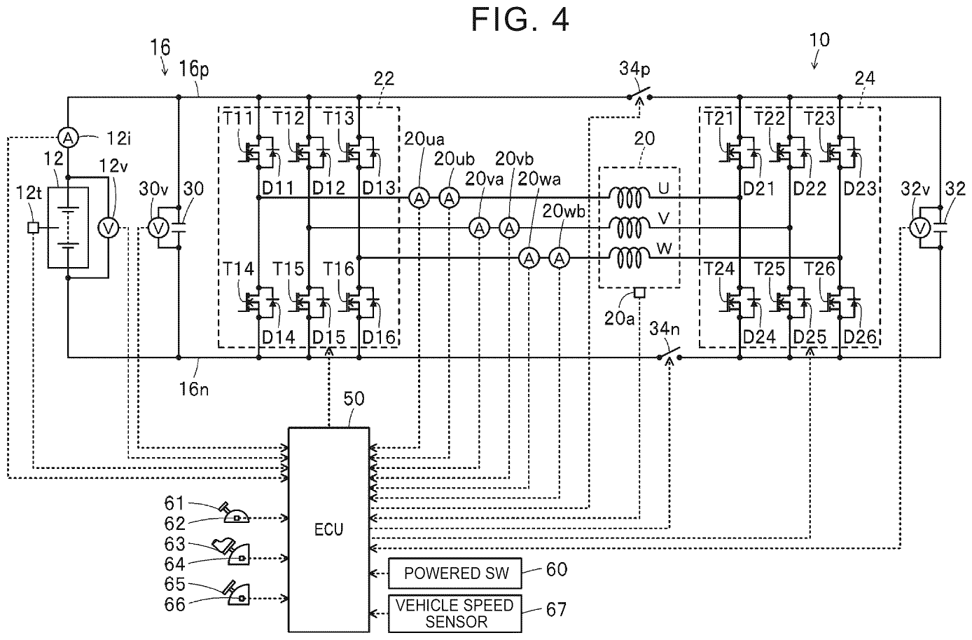

In the above embodiment, the configuration is the same as that of battery electric vehicle 10 of FIG. 1, but the present disclosure is not limited thereto. For example, as shown in battery electric vehicle 110 of the modification of FIG. 4, the disclosed electrified vehicle may further comprise a capacitor 32 and a changeover switch 34n in addition to the same hardware configuration as that of the battery electric vehicle 10 of FIG. 1. The capacitor 32 is connected to the vicinity of the second inverter 24 in the power line 16. The voltage VL from the voltage sensor 32v that detects the voltage VL of the capacitor 32 is input to the ECU 50. The changeover switch 34n is provided between the first and second inverters 22, 24 of the negative-side line 16n, and is controlled by the ECU 50. In this battery electric vehicle 110, in the identifying process, the changeover switches 34p, 34n may be switched from the on state to the off state. In the Y-drive limp home mode, the changeover switches 34p, 34n may be maintained in the off state.

In the above embodiments, the electrified vehicle is the battery electric vehicles 10, 110. However, the present disclosure is not limited to this. For example, the electrified vehicle of the present disclosure may have a hybrid electric vehicle configuration that further includes an engine in addition to the same hardware configuration as that of the battery electric vehicles 10, 110. In addition, the electrified vehicle of the present disclosure may have a fuel cell electric vehicle configuration that further includes a fuel cell in addition to the same hardware configuration as that of the battery electric vehicles 10, 110.

The correspondence between the main elements of the embodiments and the main elements of the disclosure described in the section “SUMMARY” will be described. In the embodiment, the battery 12 corresponds to the “energy storage device,” the motor 20 corresponds to the “motor,” the first inverter 22 corresponds to the “first inverter,” and the second inverter 24 corresponds to the “second inverter.” Further, the changeover switch 34p corresponds to a “changeover switch,” and the ECU 50 corresponds to a “control device.”

The correspondence between the main elements of the embodiment and the main elements of the disclosure described in the section “SUMMARY” is an example for specifically describing the mode for carrying out the disclosure described in the section “SUMMARY.” Therefore, this correspondence is not intended to limit the elements of the disclosure described in the section “SUMMARY.” That is, the disclosure described in the section “SUMMARY” should be interpreted based on the description in that section, and the embodiments are merely specific examples of the disclosure described in the section “SUMMARY.”

Hereinafter, while embodiments for carrying out the present disclosure are described by using embodiments, it is needless to say that the present disclosure is not limited to such embodiments, and can be implemented in various forms without departing from the gist of the present disclosure.

The present disclosure is applicable to the manufacturing industry of electrified vehicles etc.

What is claimed is:

1. An electrified vehicle including: an energy storage device; a motor for traction including a three-phase open-end winding; a first inverter connected to a power line and connected to a first end of the three-phase open-end winding; a second inverter connected to the power line on an opposite side of the first inverter from the energy storage device and connected to a second end of the three-phase open-end winding; a changeover switch provided on a positive-side line of the power line between the first and second inverters; and a control device configured to control the first and second inverters and the changeover switch, the electrified vehicle comprising first and second current sensors for each of three phases, the first and second current sensors for each of the three phases being attached to a corresponding phase of the three-phase open-end winding, wherein the control device is configured to
when any of the three phases is a first exceeding phase while the electrified vehicle is traveling with the changeover switch being in an on state and with the motor being driven by the first and second inverters, determine that there is an abnormality in one of the first and second current sensors of the three phases, turn off the changeover switch, and control the first and second inverters such that a current based on a back electromotive force generated by rotation of the motor flows through a circuit configured by the first inverter, the motor, and the second inverter, the first exceeding phase being a phase for which a difference between detection values of the first and second current sensors is greater than a first threshold,
identify an abnormal current sensor out of the first and second current sensors of the three phases, based on the first exceeding phase or a second exceeding phase, and on either a sum of detection values of the first current sensors of the three phases or a sum of detection values of the second current sensors of the three phases, whichever has a larger absolute value, the second exceeding phase being a phase for which the difference between the detection values of the first and second current sensors is greater than a second threshold, and
control the first and second inverters such that the electrified vehicle travels in a limp home mode without using the abnormal current sensor.

2. The electrified vehicle according to claim 1, wherein, when the control device determines that there is an abnormality in one of the first and second current sensors of the three phases and turns off the changeover switch, the control device turns on an upper arm of the first and second inverters and turns off a lower arm of the first and second inverters.

3. The electrified vehicle according to claim 1, wherein, when the control device identifies the abnormal current sensor, the control device causes the electrified vehicle to travel in the limp home mode by maintaining the changeover switch in an off state, establishing a neutral point at the second end of the three-phase open-end winding, and controlling the first and second inverters to drive the motor through switching of the first inverter.
